(19) United States
(12) Patent Application Publication
(10) Pub. No.: US 2026/0059031 A1
(43) Pub. Date: Feb. 26, 2026

(54) METHODS AND DEVICES FOR TRANSMITTING AND RECEIVING COMMUNICATION FRAMES OVER LORA MESH NETWORKS IN REAL TIME

(71) Applicant: Stonewall Defense, LLC, Troy, NY (US)

(72) Inventors: Charles Hicks, Loudonville, NY (US); Ryan Quinn, Selkirk, NY (US); Nicholas Campbell, Albany, NY (US); Richard H. Newkirk, Albany, NY (US)

(73) Assignee: Stonewall Defense, LLC, Troy, NY (US)

(21) Appl. No.: 19/307,004

(22) Filed: Aug. 21, 2025

Related U.S. Application Data
(60) Provisional application No. 63/685,771, filed on Aug. 22, 2024.

(51) Int. Cl. H04L 69/321; H04L 67/12; H04W 28/02; H04W 64/00

(52) U.S. Cl. CPC H04L 69/321; H04L 67/12; H04W 28/0236; H04W 64/00

(57) ABSTRACT

Devices within a LoRa mesh telecommunications network include a specially programmed microcontroller that is specially configured to wirelessly relay or retransmit communication frames in real time.

### RELATED APPLICATION

This application claims priority to U.S. Provisional Application No. 63/685,771 filed Aug. 22, 2024 (the “'771 Application”). This Application incorporates by reference the entire disclosure of the '771 Application as if it were set forth in full herein.

This section introduces aspects that may be helpful to facilitate a better understanding of the described disclosure(s). Accordingly, the statements in this section are to be read in this light and are not to be understood as admissions about what is, or what is not, in the prior art.

A telecommunications “stack” (hereafter “stack”) may be designed to support various communication standards. A stack typically consists of layers, where each layer satisfies specific communication standards. One existing and common telecommunication model that describes the various layers is known as the Open System Interconnection model (“OSI model”). Existing stacks are designed to support a few different telecommunication standards and operational behaviors as it relates to flow control.

However, sometimes there is no need to utilize all of the communication standards and/or layers that are a part of a stack. Other times flow controls may prevent needed behavior of the stack.

In particular, when a stack comprises an application that is stored as electronic instructions in the electronic memory of a microcontroller the stack may contain seldom used (if at all) electronic instructions (i.e., code). Such code can consume precious electronic memory (e.g., program flash space) which is typically limited to a certain amount. Such code may also cause execution delays affecting or even preventing the microcontroller and its connected devices from operating effectively. Thus, such a microcontroller may fail to meet expected performance measurements or parameters.

Accordingly, there is a need for better methods, systems and devices for configuring a stack in a device used in a telecommunications network.

One such network is a Long Range (LoRa), wireless telecommunication network that is used to connect Internet-of-Things (IoT) devices. Two types of devices used in a LoRa network are so-called TAG and gateway devices (sometimes referred to simply as a “gateway”). Existing gateway and TAG devices are challenged when real time operation is desired. As used herein the phrase “real time” means a TAG device is transmitting data indicating its location at least every second.

Accordingly, there is a need for better methods, systems and devices for configuring a stack used in a real time, LoRa telecommunications network.

Yet another challenge in developing a real time LoRa telecommunications network is the need to track the location of a plurality of nearby TAG devices and, in particular, their distance from a gateway. Because a typical LoRa network relies upon wireless communications, the possibility exists that a TAG device may move to a position that is beyond its transmission range from the gateway. One solution may be to allow a nearby TAG device that is within range of the same gateway to relay communication frames (e.g., data) it receives from the out-of-range TAG device to the gateway and vice-versa.

However, simply enabling a nearby TAG device to relay frames from an out-of-range TAG device may cause a “communication storm” (i.e., overload the relaying TAG device or gateway if there are many nearby TAG devices capable of relaying data).

Accordingly, there is a need to develop better methods, systems and devices to enable efficient relaying of messages among many TAG devices in a LoRa telecommunications network.

### SUMMARY

The inventors describe a number of different embodiments of inventive methods, systems and devices that provide advantages over existing TAG and gateway devices used in a LoRa wireless telecommunications network.

In embodiments, an exemplary IoT TAG or gateway device may include a microcontroller that is adapted or configured to provide real-time transmission and reception of telecommunication frames from, and to, other similarly configured, physical devices within the same LoRa mesh, telecommunications network.

Still further, the exemplary TAG or gateway devices may be substantially reduced in size as compared to existing TAG or gateway devices.

In an embodiment, a long range (LoRa) wireless telecommunications module may comprise a microcontroller configured to execute computer program code stored within at least one first electronic memory (“first memory”) to cause the LoRa module to complete stored task items stored in a second memory thereby further causing a communication frame to (i) be processed in real time so that the frame may be transmitted by a transceiver without repeatedly passing the frame from one layer of a communication stack to another layer of the communication stack or (ii) be received and processed by the transceiver in real time without repeatedly passing the frame from the one layer of the communication stack to the other layer of the communication stack.

The LoRa module may comprise: (i) part of an Internet-of-Things (IoT) device, or (ii) part of TAG device, or (iii) part of gateway.

In an embodiment the first memory may comprise an electronic flash memory.

The microcontroller may be further is configured to execute computer program code to: receive the communication frame containing data to be transmitted or received; store the frame in a section of the second memory (“task item section”); execute code of a given layer of the communication stack using the stored communication frame (a “call”) rather than consuming processing time of the microcontroller to electronically process the communication frame in accordance with code from a section of the first memory.

Yet further, the microcontroller may further execute stored code within the first memory to generate a pointer which directs a section of the first memory (“next layer”) to access the communication frame within a stored task item section of the second memory. Still further, the microcontroller may further execute stored code within the first memory to: receive the communication frame from the task item section; execute a function or process on the communication frame as if the communication frame is a task item.

In an embodiment, the first memory and the second memory may be combined into one memory.

Another LoRa wireless telecommunications module may also comprise: a microcontroller configured to execute computer program code stored within at least one first electronic memory to, control generation of a first pointer that directs a layer of a communication stack stored in the at least one first electronic memory to access a communication frame as a task item stored in a second memory and then execute a function or process using the so accessed frame in accordance with accessed the task item.

In addition to the LoRa modules so far described this disclosure provides additional modules. For example, another LoRa wireless telecommunications module may comprise: a microcontroller configured to execute computer program code stored within at least one first electronic memory to, store and execute service function code in a reference layer of a communication stack; generate a second pointer; and access code stored in a task manager section, wherein the accessed code comprises a task item that includes a communication frame to be transmitted or a received communication frame. The microcontroller of such a LoRa wireless telecommunications module may be further configured to execute computer program code stored within the at least one first electronic memory to determine whether the task item refers to the reference layer, and upon determining that the task item refers to the reference layer execute the task item in accordance with code of the reference layer to ensure real time processing of the communication frame to be transmitted or the received communication frame, or upon determining that the task item does not refer to the reference layer ignores the task item and execute subsequent code of the reference layer.

In addition to LoRa modules the disclosure also provides TAG devices in or for LoRa wireless telecommunications networks. One exemplary TAG device may comprise: an electronic microcontroller configured to execute computer program code stored within at least one electronic memory to cause the TAG device to determine when an electronic storage capacity of a tag location tracking section of the microcontroller is approaching a maximum capacity, and upon detecting a maximum or near maximum storage capacity of the tag location tracking section, updating previously stored position data stored within the tracking section indicating previous positions of one or more other TAG devices with present position data.

The microcontroller of such a TAG device may be further configured to execute computer program code in order to receive the present position data from the one or more other TAG devices.

Another exemplary TAG device in, or for, a LoRa wireless telecommunications network may also comprise: an electronic microcontroller configured to execute computer program code stored within at least one electronic memory to cause the TAG device to determine whether a received communication frame is intended for the TAG device, wherein if the communication frame is not intended for the TAG device, further execute computer program code stored within a tag location tracking section to determine whether the tag location tracking section has stored a position of a second TAG device that sent the communication frame before executing computer program code from a frame relaying section; determine whether the communication frame contains position data from a third TAG device; and store the communication frame within the tag location tracking section if the frame contains position data from the third TAG device before executing code from the frame relaying section.

In such a TAG device the electronic microcontroller may be further configured to execute computer program code stored within the at least one electronic memory to cause the TAG device to determine a destination device of the communication frame; and determine whether or not the second TAG device has a transmission signal strength to transmit the frame directly to the destination device without the frame being relayed or re-transmitted.

Further, the microcontroller may be further configured to store the communication frame in an electronic buffer memory upon determining that the transmission signal strength of the second TAG device is insufficient to allow the communication frame to be received at the destination device, wherein the destination device may comprise the third TAG device.

In an exemplary embodiment, such a microcontroller of a TAG device may be further configured to: initiate an electronic clock timer; monitor a time value; compare the monitored time value to a time delay value; and when the comparison indicates that the monitored time value equals or exceeds the time delay value, initiate re-transmission or relaying of the communication frame from the buffer, provided, no interrupt signal is received.

Still further, the microcontroller of such a TAG device may be further configured to generate the time delay value based on one or more of the following: a generated random number; a battery state-of-charge (SOC) of a transmitting TAG device; a signal strength of gateway device; or a distance from a gateway device of the transmitting TAG device.

### BRIEF DESCRIPTION OF THE DRAWINGS

FIG. 1 depicts a simplified diagram of a LoRa, wireless mesh telecommunications network in accordance with embodiments of the disclosure.

FIG. 2 depicts a simplified block diagram of an inventive TAG device in accordance with embodiments of the disclosure.

FIG. 3 depicts a simplified block diagram of a LoRa transceiver module according to embodiments of the disclosure.

### DETAILED DESCRIPTION, WITH EXAMPLES

Throughout the following description and drawings, like reference numbers/characters refer to like elements. It should be understood that although specific embodiments are discussed herein, the scope of the disclosure is not limited to such embodiments. On the contrary, it should be understood that the embodiments discussed herein are for illustrative purposes, and that modified and alternative embodiments that otherwise fall within the scope of the disclosure are contemplated. It should also be noted that one or more exemplary embodiments may be described as a process or method (the words “method” may be used interchangeably with the word “process” herein). Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method if, for example, such steps are known by those skilled in the art. It should be understood that when a system or device, or a component or element of a system or device, is referred to, or shown in a figure, as being “connected” to (or other tenses of connected) another system, device (or component or element of a system or device) such systems, devices, components or elements may be directly connected, or may use intervening components or elements to aid a connection. In the latter case, if the intervening systems, devices, components or elements are well known to those in the art they may not be described herein or shown in the accompanying figures for the sake of clarity. It should be understood that, as used herein, the designations “first”, “second”, “third”, “fourth” etc., are used to purely distinguish one parameter, element or step in a system, device or process from another and does not indicate a priority or order. The parameters, elements or steps can sometimes be re-designated (i.e., re-numbered) and it would not affect the systems, devices or methods described by the present disclosure.

As used herein, the term “and/or” includes any and all combinations of one or more of the associated listed items. As used herein, the singular forms “a,” “an” and “the” are intended to include the plural form, unless the context and/or common sense indicates otherwise. It should be understood that the terms “comprises”, “comprising,”, “includes” and/or “including”, when used herein, specify the presence of stated features, steps, operations, elements, and/or components, but do not preclude the presence or addition of one or more other features, steps, operations, elements, components, and/or combinations thereof. As used herein the terms “configured to”, “adapted to”, and “operable to” mean “functions to” unless the context, common sense or knowledge of one skilled in the art indicates otherwise. More particularly, when used to describe the operation of an electronic microcontroller the phrases “configured to”, “adapted to”, and “operable to” may mean such a microcontroller executes computer program code (i.e., electronic instructions) stored in one or more electronic memories to complete certain inventive functions, features or processes.

It should be understood that the phrase “microcontroller” means one or more electronic devices (e.g., specialized programmed electronic processors) that is (are) operable to be specially programmed to retrieve and execute specific computer program code (instructions) stored as electronic signals in electronic memory, where a set of such stored specific code may constitute steps in an inventive process or method (e.g., an inventive communications stack), and/or may be executed by an inventive device (e.g., a TAG device or a gateway) to complete an inventive function(s), such as completing the functions or steps of real-time: controlling, relaying, retransmitting, accessing, retrieving, tracking, sensing, monitoring, receiving, transmitting, forwarding, sending, inputting, outputting, executing, storing, completing, calling and generating to name just a few of the inventive functions/processes that may be completed by a microcontroller executing such stored code.

The phrase “at least one microcontroller, and its' at least one electronic memory for storing electronic instructions or computer program code that cause” means a microcontroller and its onboard or connected electronic memory within a TAG device, gateway or another device that is used to complete a function, feature or step listed above or elsewhere herein. Relatedly, the phrase “microcontroller executes code” is a concise way of indicating that a microcontroller and an onboard or connected electronic memory within a TAG device, gateway or another device may be configured to complete a function, feature or step listed above or elsewhere herein.

As used herein the phrases “electronic instructions” and “computer program code” may be used interchangeably herein and have the same meaning unless otherwise stated.

Further, it should be understood that each embodiment of a microcontroller described herein is further configured with the necessary hardware and firmware components to enable each to process stored computer program code (sometimes referred to simply as “electronic code” or simply as “code”) and complete inventive functions/steps in a process much faster than humanly possible. Each of the electronically based embodiments of the present disclosure cannot practically be implemented in any amount of time that would be acceptable to one skilled in the art (e.g., in a matter of seconds) using human beings as substitutes for the electronic microcontrollers, processes and devices described herein. Accordingly, the use of humans as substitutes for such methodologies is contrary to the objectives of the disclosure and does not result in the advantages provided by the disclosure.

To avoid repetition and for the sake of clarity it should be understood that when the operation, features or functions of a “communications stack” is described herein that such an operation, feature or function involves the retrieval and execution of electronic code by one (or more) microcontrollers from at least one electronic memory. Further, it should be understood that the at least one memory and computer program code stored thereon may be configured to, with the at least one microcontroller, to cause a device (e.g., TAG device, gateway) at least to control, relay, retransmit, track, sense, monitor, access, retrieve, receive, transmit, forward send. input, output, execute, store, complete, call and generate in real-time to name just a few of the inventive operations, features and/or functions that may be completed by a TAG device or gateway disclosed herein.

As used herein the word “: section” when used to describe a layer of a communication stack means an electronic part of a microcontroller that stores code and/or associated data, such as an electronic memory.

When used herein the phrases “call”, “calls” or “calling” mean a process of executing stored computer program code by a microcontroller that invokes a subroutine or function. For example, one type of call may be a “function” call that occurs during execution of a first set of stored code which in turn causes the microcontroller to execute code from a different, second section of its stored code in order to complete a function or subroutine. It should be understood that a function call involves the execution of a series of related code by a microcontroller (i.e., steps). After the microcontroller has completed the steps of the function call the microcontroller reverts back (i.e., “returns’) the code in the first section. Another type of “call’ is a “call stack”. In an embodiment, the call stack may comprise data structured to manage function calls and returns. A microcontroller may execute a call stack in a last-in, first-out (LIFO) manner. For example, when a function is called, the return address and possibly other state information are pushed onto a stack. When the function is completed, the return address and possibly other state information are deleted from the stack to restore a previous operational state to allow the microcontroller to resume a previous operation.

As noted previously, the phrase “real time” means at least a TAG device is transmitting data indicating its physical location at least every second.

As used herein the word “exemplary” means a non-limiting example of an inventive function, feature or step in an inventive system, device or method disclosed herein.

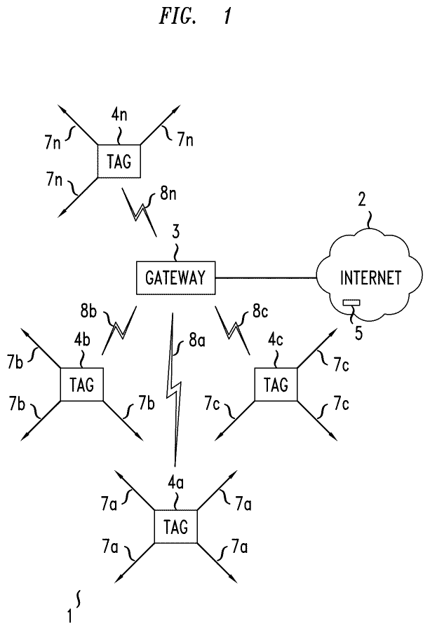

Referring now to FIG. 1 there is depicted a simplified block diagram of a telecommunications mesh network 1 that may include one or more TAG devices 4a to 4n (where “n” designates the last TAG device), one or more electronic network edge devices 3 (e.g., gateways) and one or more servers 5 located within an Internet-based network 2.

In accordance with an embodiment of the disclosure, the network 1 may comprise a LoRa, wireless communications network, each of the one or more TAG devices 4a to 4n may comprise an IoT device (or devices) and the network edge devices 3 may each comprise electronic gateways. For the sake of clarity, only a single electronic gateway 3 (hereafter “gateway”) and single server 5 are shown, though it should be understood that this is merely exemplary and that an inventive LoRa telecommunications network 1 may include more than one gateway and/or server. In embodiments, each of the TAG devices 4a to 4n and gateway 3 may be separated from one another over a long distance (e.g., 1 to 2 miles).

In an embodiment each of the TAG devices 4a to 4n may be configured to electronically sense, track, monitor and/or identify in real-time the physical location, condition and/or status, for example, of a wired or wirelessly connected, associated device (e.g., sensor, actuator) (not shown for clarity) or measure a parameter (e.g., light, motion, temperature, humidity). In an embodiment, the TAG devices 4a to 4n and their connected, associated devices (hereafter “connected devices” or singularly “connected device”) may be powered by one or more batteries, for example.

Each of the TAG devices 4a to 4n may be configured to electronically transmit, relay, re-transmit and/or receive data (e.g., a communication frame) representing the sensed, tracked or monitored location, condition or status, for example, of another TAG device 4a to 4n using low-power, low data rate communication signals (data, control signals). In an embodiment, the low-power, low data rate communication signals exchanged between TAG devices 4a to 4n and/or gateway 3 may comprise short, IoT type messages.

In some embodiments each inventive TAG device 4a to 4n may be integral with its connected device. In other embodiments each inventive TAG device 4a to 4n may be physically connected to its connected device. In still other embodiments each inventive TAG device 4a to 4n may be wirelessly connected to its connected device.

Yet further, in the case where one or more of the connected devices comprise one or more different types of sensors (e.g., temperature, humidity, GPS, accelerometers) such devices may be configured to sense, collect, track, manage and/or transmit (or receive) data (e.g., about the physical environment, assets, vehicles, livestock, and logistics).

In embodiments, each of the TAG devices 4a to 4n may be wirelessly, communicatively connected to the gateway 3 using LoRa radio frequency (RF) modulation processes. As explained further herein, it can be said that the inventive TAG devices 4a to 4n provide the gateway 3 (and server 5) with the ability to track the location and status of TAG devices 4a to 4n and their connected devices (e.g., IoT devices) in real time.

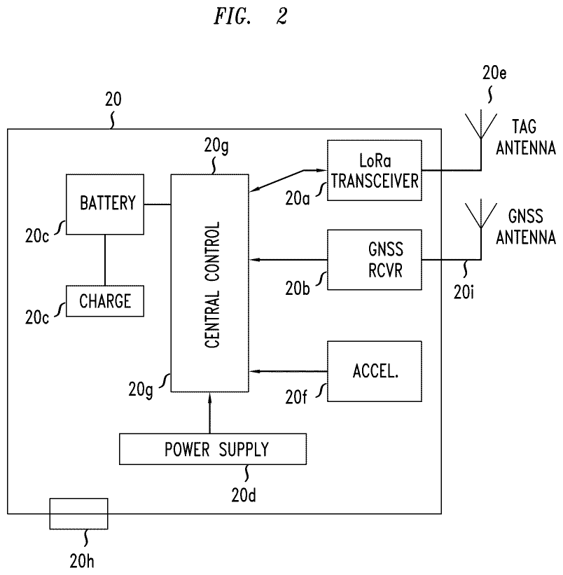

Referring now to FIG. 2 there is depicted a simplified block diagram of an exemplary printed circuit board (PCB) 20 of an inventive TAG device 4a to 4n (e.g., TAG device 4a) in accordance with embodiments of the disclosure. As shown the PCB 20 may be configured to support a LoRa transceiver module 20a, Global Navigation Satellite System (GNSS) receiver 20b, battery and battery charger 20c, power supply 20d, RF antenna 20e, GNSS antenna 20i, a central control unit 20g, and an accelerometer 20f to name just a few of the components the exemplary PCB 20 may support. In addition, a connector 20h (e.g., USB connector) may be attached to the PCB 20.

In embodiments, the inventors decreased the “footprint” (i.e., physical volume of space) that the inventive TAG devices 4a to 4n requires as compared to an existing TAG device by reducing the size (volume) of the PCB 20 and connector 20h.

For example, the printed circuit board (PCB) upon which components 20a to 20i reside may be reduced from a volume of 55 mm×55 mm×10 mm to at least a volume between 30 mm×40 mm×10 mm to 47 mm×50 mm×10 mm which is substantially smaller than the PCB on of an existing device. To do so, the inventors reduced the size (volume) of the GNSS receiver 20b from 9.7 mm×10.1 mm×2.5 mm to at least 4.5 mm×4.5 mm×1 mm. The reduction in size ensures that the TAG device 4a can be configured with its connected device as a wearable device.

Further, the inventors reduced the dimensions of the connector 20h (e.g., USB connector) from 1.495 cm×1.030 cm×2.35 cm to at least 1 cm×0.92 cm×0.56 cm and address sealing protection by configuring the connector in accordance with industry best practices to obtain an IP-67 rating, for example.

It should be understood that each of the TAG devices 4a to 4n (and each of the gateways 3) may comprise an inventive LoRa transceiver module 20a in accordance with embodiments of the disclosure. In an embodiment, when the transceiver module 20a is included in a gateway 3 the module may be configured as a “daughter board” in order to minimize any changes required to be made to the gateway 3.

In more detail, in one embodiment the PCB (that includes the transceiver 20a) may comprise a connector header of one “gender” (e.g., a male connector) that is configured to mate with a second connector header of an opposite gender (e.g., a female connector) that is connected to (or a part of) the gateway 3.

The respective microcontrollers of the gateway 3 and a TAG device 4a to 4n may communicate directly with each other. In an embodiment, the microcontroller within the gateway 3 may include additional firmware that is responsible for carrying out gateway-specific functions, features and processes that are unrelated to the inventive disclosures herein and are well known to one skilled in the art.

In an embodiment, a PCB containing the inventive LoRa module 20a may be of a size that does not require the enclosure of an existing gateway 3 to be altered in size (i.e., the inventive daughterboard may fit inside an existing gateway enclosure).

For purposes of the discussion that follows we will describe the LoRa transceiver module 20a as part of a TAG device 4a to 4n, though it should be understood that similar features, functions and processes described herein may be completed by a LoRa transceiver module that is part of a gateway 3.

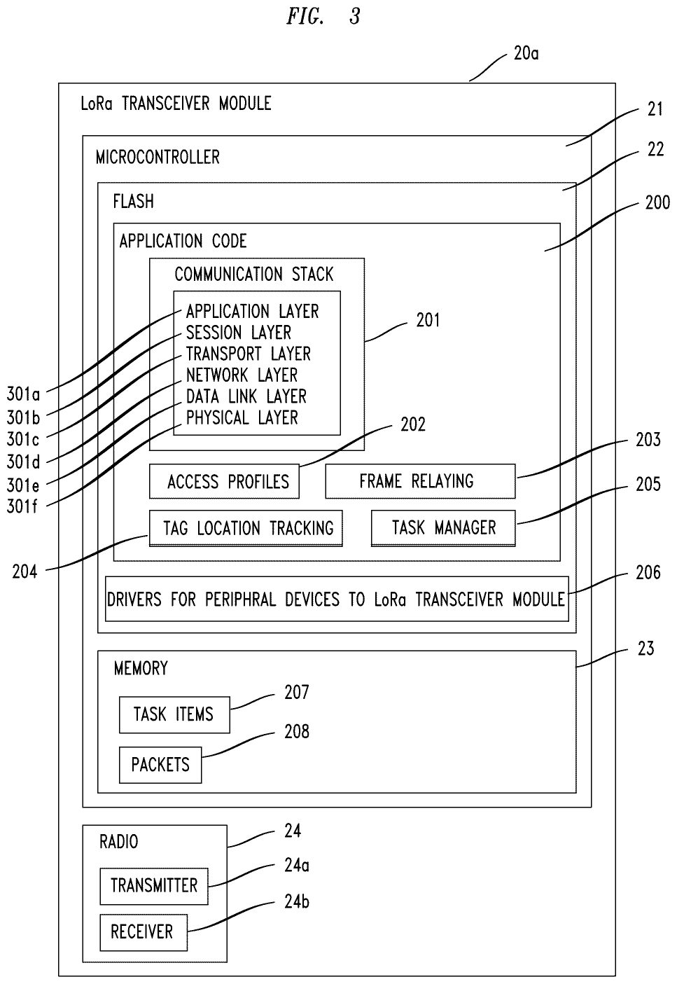

Referring now to FIG. 3 there is depicts a simplified block diagram of an inventive LoRa transceiver module 20a in accordance with embodiments of the disclosure.

In an embodiment, the inventive transceiver module 20a may comprise one or more electronic components such as a microcontroller 21. and transceiver 24, though in an alternative embodiment the microcontroller 21 and transceiver 24 may be configured to reside on different modules and/or PCBs.

The microcontroller 21 may comprise one or more electronic flash memories 22 and one or more additional electronic memories 23 while the transceiver 24 may comprise electronic transmission circuitry 24a (i.e., transmitter) and electronic reception circuitry 24b (i.e., receiver).

In an embodiment, the inventive microcontroller 21 may be configured to store a specially configured set of computer program code or electronic instructions 200 (i.e., application code) in its' flash memory 22 to control the operation of the LoRa module 20a so that a TAG device 4a to 4n or gateway 3 may wirelessly exchange (i.e., transmit and receive) low-power, low data rate communication signals between each other in real-time and/or control the operation of the LoRa module 20a so that one TAG device 4a to 4n may exchange low-power, low data rate communication signals between another so-configured TAG device 4a to 4n in real-time (e.g., from one TAG device to a second TAG device, or from one TAG device to a second TAG device to yet a third TAG device or from one TAG device to a gateway device and back again, for instance).

In an embodiment, the application code 200 may be further configured as one or more subsets 201 to 205 of specially configured, computer program code. For example, one of the subsets of specially configured, computer program code may be referred to collectively as a “communications stack” or simply “stack” 201. Other subsets of specially configured, computer program code may be referred to as “access profiles” 202, “frame relaying” 203, “tag location tracking” 204 and an inventive “task manager” 205.

As set forth below the inventors have discovered inventive configurations of the LoRa module 20a that cause components of the inventive LoRa module 20a to interact and communicate differently than components of existing LoRa modules. More particularly, in exemplary embodiments the microcontroller 21 may be configured to execute (i.e., retrieve and complete) computer program code stored as application code 200 within at least one electronic flash memory 22 (sometimes referred to as “first” memory) to cause the LoRa module 20a to complete stored task items 207 (e.g., functions, features and processes) that may be stored in the additional memory 23 (sometimes referred to as “second memory”) that thereby further cause communication frames to (i) be processed in real time so that the frames may be transmitted by the transceiver 24 or (ii) be received and processed by the transceiver 24 in real time.

For the readers benefit we first discuss some inventive configurations of the LoRa module 20a and then provide a more detailed, stack layer-by-stack layer 301a to 301n discussion of inventive processes that make use of such inventive configurations.

The inventors discovered that one way to ensure real-time processing of frames to be transmitted or received was to avoid repeatedly passing a communication frame from one layer 301a to 301n of the stack to another layer 301a to 301n. Instead, in an embodiment the microcontroller 21 may receive a communication frame that contains data to be transmitted or received (among other information, e.g., headers and footers) and store the frame in a section of the second memory 23 referred to as a task item section 207 in FIG. 3. Thereafter, as the microcontroller 21 is executing application code 200 of a given layer 301a to 301n and the execution requires a function or process to be performed using the stored communication frame (during a so-called “call”), rather than consume processing time of the microcontroller and power (as well as memory capacity) to electronically process the communication frame in accordance with code from one section of the first memory 22 (i.e., as if the frame was being passed from one layer 301a to 301n of stored application code 200) and then repeatedly process the same frame in accordance with code from another, subsequent section of the first memory 22 (as if the frame was being received after being passed at another, “next” layer 301a to 301n of stored application code 200) the inventive microcontroller 21 executes stored code from within the first memory to generate a first type of pointer (“first pointer”) which directs the subsequent section of the first memory 21 (i.e., the next layer) to access the communication frame within a stored task item 207 section of the second memory 23. Upon receiving the frame from the task item 207 section the respective next layer (i.e., code within the microcontroller 21) may execute a function or process on the communication frame to be transmitted or which has been received in accordance with code as if the communication frame is a task item.

Thus, rather than repeatedly executing code that requires the same communication frame to be repeatedly processed, the inventive microcontroller 21 generates a first pointer that controls or directs a layer 301a to 301n of its stack 201 stored in a first memory 22 to access the frame as a task item in the task item section 207 of a second memory 23 and then execute a function or process using the so accessed frame in accordance with the accessed task item. It is this inventive control of its first and second memories 22, 23 by the microcontroller 21 which reduces the number of times a communication frame must be processed that allows a frame to be transmitted in real-time or a frame that has been received to be processed in real-time. For the reader's benefit, if the first and second memories 22, 23 are combined into the same physical memory, then the microcontroller 21 may be said to be configured to control the generation of a similar pointer that directs a layer 301a to 301n of its stack 201 stored in the first memory 22 to access the frame as a task item in task item section 207 stored in the second memory 23 and then execute a function or process using the so accessed frame in accordance with the accessed task item. In either case (i.e., one memory or two memories) there is no need to repeatedly process the communication frame.

The inventors believe that reducing the number of times the frame is required to be processed before it is transmitted or upon being received may also reduce the physical size of the first memory 22 (flash memory) required to store the applications code 200 by approximately 50% of an existing size. Still further, by reducing the number of processing steps the inventors believe will reduce the electronic processing load on the microcontroller 21 by reducing the time and power (compared to an existing memory) by approximately 50% required to access, retrieve and execute the stored electronic code or instructions from the layers 301a to 301n of the stack 201 that may be involved in processing a transmitted or received communications frame through the stack 201. Such a reduction in processing load on the microcontroller 21 may help ensure that communication frames can be exchanged between TAG devices 4a to 4n or gateway 3 and their connected devices (e.g., an IoT device) via the LoRa network 1 over an increased amount of time versus existing devices (e.g., approximately 50%).

In the preceding few paragraphs it should be understood that the task items stored in task item section 207 of the second memory 23 may be initially generated by the microcontroller 21 by executing code stored in another section (layers 301a to 301n) of the first memory 22. For example, the task items associated with a communication frame to be transmitted may be generated by the microcontroller 21 by executing code stored in a data link layer 301e of the stack 201. Upon generating the task items the microcontroller 21 may store the task items in that section 207 of the second memory 23 referred to as task items section 207 in FIG. 3. Similarly, the task items associated with a communication frame that has been received may be generated by the microcontroller 21 by executing code stored in the data link layer 301e of the stack 201. Upon generating the task items the microcontroller 21 may store the task items in the same section of the second memory 23, again referred to as task items section 207.

In addition to inventively changing the way or process in which the microcontroller 21 controls the operation of its memories 22,23 to ensure real time processing of transmitted or received frames, the inventors also introduce new, inventive sections of the microcontroller 21. In an embodiment, the inventive microcontroller 21 may comprise additional code stored and embedded within each layer 301a to 301n of its communication stack 201 that function to access stored, additional, new code referred to as a task manager section 205 in FIG. 3. The addition of the code stored and embedded with each layer and the code that comprises the task manager section of code 205 serves as a double-check to ensure real time processing.

In more detail, in the processing of a frame to be transmitted or upon receiving a frame the microcontroller 21 may execute code from different layers 301a to 301n of its communication stack 201 stored in first memory 22 (flash memory). To ensure that all of the task items stored in task item section 207 of the second memory 23 (for example) are processed in real time, each layer inventively comprises new, electronically stored code. In an embodiment, the microcontroller 21 may execute this new, stored code each execution cycle (i.e., a service function is “called” every execution cycle). For the reader's reference this new, stored code in each layer 301a to 301n may be referred to as “service function” code.

Continuing, upon executing the service function code of a given layer 301a to 301n the microcontroller 21 may generate a second type of pointer (“second pointer”). This second pointer causes the microcontroller 21 to pause the execution of a next set of code and, and, instead, access code stored in a task manager section 205. For the reader's benefit this given layer may be referred to as a “reference” layer.

The code stored in the task manager section 205 may comprise a task item that includes the communication frame to be transmitted or a received communication frame (i.e., a frame that has been received).

Upon accessing the task item within the task manager section 205 the microcontroller 21 may first be configured to determine whether the task item should be executed at that time. Said another way, the microcontroller 21 may determine whether the task item relates to the reference layer. If, upon determining that the task item refers to the reference layer, then the microcontroller 21 executes the task item in accordance with code of the reference layer to ensure that each task is completed for each layer 301a to 301n to thereby ensure real time, accurate processing of a frame to be transmitted or one the received communication frame (i.e., no task items are overlooked or skipped). If, however, the microcontroller 21 determines that the task item does not refer to the reference layer (i.e., upon determining that the task item does not refer to the reference layer), then the microcontroller 21 ignores the task item (i.e., does not execute code related to the task item) and begins to execute the subsequent code of the reference layer (i.e., releases the pause).

By causing a microcontroller 21 to pause the execution of code related to each layer 301a to 301n of a stack 201 based on the execution of service function code embedded in each layer 301a to 301n is believed to enable the carry-on of tasks and the ability of the LoRa transceiver module 20a to prioritize sending a different message than was first issued for transmission.

As noted near the very beginning of our discussion, providing real time processing of transmitted or received communication frames also involves ensuring that a TAG device 4a to 4n is within range of a gateway 3. If it is not, then a method is required to allow a frame to be reliably relayed to a gateway 3 (and vice-versa) without causing a “communication storm” (i.e., overloading the relaying TAG device or gateway if there are many nearby TAG devices capable of relaying data).

Realizing this, the inventors discovered a method that enables the efficient relaying of frames among many TAG devices 4a to 4n that includes configuring each TAG device 4a to 4n with the ability to strategically track other nearby TAG devices 4a to 4n.

Among the challenges faced by the inventors was the determination that a given TAG device 4a to 4n may not have the memory resources (i.e., size or speed) to track all, or some, other nearby TAG devices.

Accordingly, in embodiments the inventors discovered methods that allow each TAG device 4a to 4n to determine the position of certain surrounding, nearby TAG devices 4a to 4n and their distances from a gateway 3 and then determine if a communication frame (sometimes referred to as a “message” herein) received from a nearby TAG device 4a to 4n needs to be relayed based on the determined positions and distances.

Further, because more than one nearby TAG device 4a to 4n may be capable of relaying a frame, the inventors discovered methods for determining which nearby TAG device 4a to 4n (or devices) should relay the frame.

In embodiments, the inventors now discuss some inventive, frame relay methods that ensure that a frame may be received, processed and then re-transmitted or relayed without colliding or interfering with the transmission of frames from other TAG devices 4a to 4n in real time, and without re-transmitting or relaying a frame that has already been retransmitted or relayed.

An example may help the reader understand the challenges addressed by the inventors.

Referring back to FIG. 1, in one embodiment an inventive microcontroller 21 of TAG device 4b or 4c may determine the position of the TAG device 4a and its distance from gateway 3. Thereafter, TAG device 4b or 4c may further determine that TAG device 4a is at a distance away from the gateway 3 (e.g., over 5 kilometers away) such that the LoRa transceiver module 20a of TAG device 4a does not have a transmitter 24a capable of transmitting communication frames at a sufficient signal strength directly to gateway 3 via channel 8a in order for frames to be received correctly because the signal is a low-power, low data rate information bearing signal. Accordingly, TAG device 4b or 4c may receive a communication frame from TAG device 4a and relay or re-transmit the frame to gateway 3 (or, alternatively, another TAG device 4a to 4n) via telecommunication channel 8b or 8c in real-time as. a low-power, low data rate information bearing signal. In an embodiment, the gateway 3 may then relay or re-transmit the received communications frame to the server 5.

Similarly, communication frames may be passed from the server 5 to a gateway 3 and on to a TAG device 4b or 4c which then may relay or re-transmit the frame to another TAG device 4a.

In more detail and with reference to FIG. 3, upon receiving a frame from TAG device 4a the receiver 24b of LoRa transceiver module 20a of either TAG devices 4b or 4c may store the frame and generate a signal indicating it has received a new frame. This signal is then sent to its microcontroller 21. Upon receiving the signal indicating a new frame has been received, the microcontroller 21 may be configured to execute code stored in the data link layer 301e of its stack 201.

For example, using TAG device 4b as the device that receives the frame, the microcontroller 21 of TAG device 4b may inventively execute code that detects the address information (e.g., in a payload) within the received frame and determines whether the address indicates the frame was intended to be received by TAG device 4b or another TAG device 4a to 4n. If the frame is not addressed to TAG device 4b then its microcontroller 21 further inventively executes code in the data link layer 301e to determine if the frame contains data indicating the position of TAG device 4a. If it does contain position information, the microcontroller 21 inventively executes additional tag location tracking code stored in section 204 in FIG. 3. In embodiments, section 204 of microcontroller 21 also stores data in its memory (not shown) that indicates the positions of TAG devices 4a to 4n, for example.

In embodiments, the memory capacity (i.e., size) of section 204 (i.e., of the microcontroller 21 of a LoRa transceiver 20a) is typically limited. Realizing this, the inventors configured the microcontroller 21 to execute computer program code stored within at least one of its electronic memory to cause the TAG device to determine when the electronic storage capacity of the tag location tracking section 204 is approaching its maximum capacity. Upon detecting a maximum or near maximum storage capacity of section 204 the microcontroller 21 may be configured to update previously (older) position data stored within section 204 indicating the previous positions of one or more other TAG devices 4a to 4n with present (newer) position data indicating the present positions of the one or more other TAG devices 4a to 4n by, for example, replacing the previous, older data within section 204 with present, newer position data.

It should be understood that a given TAG device 4a to 4n is not typically preloaded with data tables that indicate the positions of nearby TAG devices 4a to 4n (and their distance to a gateway 3). Thus, in an embodiment, the position data that is ultimately stored in the tag location tracking section 204 of microcontroller 21 of each TAG device 4a to 4n is populated as each individual TAG device presently “listens” to every other one or more, nearby TAG devices 4a to 4n (i.e., receives present frames from the other TAG devices 4a to 4n).

Accordingly, in embodiments each inventive TAG device 4a to 4n builds (i.e., receives, processes and stores) the current and present, last known position of each nearby TAG device 4a to 4n based on the last received frame from each nearby device.

The inventors have inventively configured a microcontroller 21 to execute additional computer program code stored within at least one of its electronic memories to complete additional functions and features. For example, FIG. 3 also includes a frame relaying section 203 of the first or flash memory 21. Accordingly, when the microcontroller 21 of a receiving TAG device 4a to 4n may determine whether a communication frame is intended for the receiving TAG device. Thereafter, if the microcontroller 21 determines that a received frame is not intended for it as described previously the microcontroller 21 may execute code stored within a section of a memory 22, 23, such as the tag location tracking section 204 for example to determine whether its tag location tracking section 204 has already stored the position of the TAG device that had sent the frame (may be referred to as “second TAG device” in the context of the present paragraphs). Said another way, in an embodiment, before the microcontroller 21 executes code stored in the frame relaying section 203 the microcontroller 21 has previously determined (by executing code in the tag location tracking section 204) whether or not the newly received frame contained position data from a new TAG device 4a to 4n (may be referred to as a “third TAG device” in the context of this paragraph), and if the frame is new, the position data is then stored within tag location tracking section 204 before the microcontroller 21 executes code from the frame relaying section 203.

Still further, upon receiving a frame the microcontroller 21 may execute code that determines the signal strength of the received frame by accessing information stored in an access profiles section 202. Thereafter, after the microcontroller 21 has determined the position of the TAG device 4a to 4n that transmitted the frame, the microcontroller 21 may execute code from its flash memory 22 for example to determine the target destination device of the received frame (e.g., another TAG device 4a to 4n or a gateway 3) as well as executing code that determines whether or not the transmitting TAG device 4a to 4n (e.g., a second TAG device) has the transmission signal strength to successfully transmit the frame directly to the destination device (which may be a third TAG device) without the frame being relayed or re-transmitted by accessing information from the access profile section 202. If the microcontroller 21 determines that the signal strength of the transmitting TAG device 4a to 4n is insufficient to allow the frame to be successfully received at the destination device, then the microcontroller 21 executes further code stored in the frame relay section 203 to store the received frame in an electronic buffer memory (hereafter “buffer”). Once stored, the frame may potentially be re-transmitted or relayed by the receiving TAG device 4a to 4n.

In an embodiment, the inventors have discovered methods to reduce the unnecessary retransmission or relaying of frames that have already been re-transmitted or relayed. That is to say, because each inventive, nearby TAG device 4a to 4n may receive the identical frame from the same transmitting (originating) TAG device 4a to 4n the inventors discovered a way to prevent each receiving TAG device 4a to 4n from relaying or re-transmitting the same frame.

In more detail, in an embodiment when a frame is saved in the buffer the microcontroller 21 may execute code stored in its flash memory to initiate an electronic clock timer. Thereafter, the microcontroller 21 may execute code that monitors the time value (i.e., time period) and compares the monitored time value to a generated, computed or stored time delay value. In an embodiment, the microcontroller 21 may not execute code to initiate the transmission of the stored frame in the buffer of a receiving TAG device 4a to 4n until the comparison indicates that the monitored time value equals or exceeds the generated, computed or stored time delay value (i.e., until the time delay value has been reached or exceeded). Once the time delay value has been reached or exceeded, the microcontroller 21 may begin to execute code that initiates the re-transmission or relaying of the frame from the buffer, provided, however the microcontroller 21 does not receive an interrupt signal.

In embodiments, the microcontroller 21 may be configured to generate or compute a time delay value based on a number of other factors or values, including, for example, one or more of the following: a generated random number; a battery state-of-charge (SOC) (of a transmitting TAG); a signal strength of gateway; and a distance from a gateway (of a transmitting TAG device), for example.

In embodiments, in generating or computing the time delay value the microcontroller 21 may apply different, stored or variable “weights” to each of the above factors or values which may reduce or increase the contribution that each factor/value has on the computed time delay value.

In other instances, a relaying TAG device 4a to 4n with a higher SOC may have a shorter time delay value and, therefore, such a value may be reached faster than a TAG device 4a to 4n with a lower SOC and higher time delay value. In an embodiment, the shorter the time delay value the more likely it is that a frame may be relayed or re-transmitted from such a TAG device 4a to 4n.

Relatedly, the fact that different TAG devices 4a to 4n may have different time delay values implies that one receiving TAG device 4a to 4n may relay or re-transmit the same frame faster than another TAG device with a longer time delay value. However, it is highly desirable to prevent a TAG device 4a to 4n with a longer time delay value from re-transmitting or relaying the same frame that has previously been re-transmitted or relayed in order to avoid “communication storms”.

Realizing this, the inventors provide a method of preventing multiple re-transmissions or relaying of the same frame by multiple TAG devices 4a to 4n.

In more detail, before a computed time delay value has been reached, a receiving TAG device 4a to 4n that has already received and stored the frame may receive the same frame from a different TAG device 4a to 4n. Under such circumstances the microcontroller 21 of the receiving TAG device may receive an interrupt signal from LoRa receiver 24b, for example, that causes the microcontroller 21 to execute code that erases or deletes the frame from the buffer thereby reducing the chances that the same frame will be relayed or re-transmitted multiple times, while also reducing the chances of a “communication storm” (it being understood that the receipt of the same frame at a receiving TAG device is an indication that the frame has already been relayed or re-transmitted from another nearby TAG device 4a to 4n).

Conversely, if a same or similar frame has not been received by a receiving TAG device 4a to 4n by the time a time delay value has been reached, then, the microcontroller 21 of the receiving TAG device may begin to execute code that initiates the re-transmission or relaying of the frame from the buffer.

Having discussed some of the inventive features, functions and processes of the disclosure, we now turn to a layer-by-layer 301a to 301n discussion of the layers shown in FIG. 3.

In an embodiment the electronic instructions of the communications stack 201 may be configured to include the following layers of code 301a to n (where “n” indicates the last layer of code), where each layer of code (or simply “layer” for the sake of brevity) comprises specially configured, computer program code:

### Layer Name Description

Application 301a and data values.

Performs various tasks as specified by task IDs

Session 301b Service the active tasks

Transport 301c Message flow control

Network 301d Frame addressing, configuration, and traffic control

Data Link 301e Transmission and reception

Physical 301n Controls the radio hardware configuration, operation, read and writes data frames.

As noted previously, the inventors discovered that simply enabling a TAG device 4a to 4n to relay or re-transmit a message (e.g., communication frame) from another TAG device may cause a “communication storm” (i.e., too many messages being exchanged).

Accordingly, the inventors discovered that to effectively relay or re-transmit messages from among a plurality of TAG devices 4a to 4n requires each TAG device 4a to 4n to be capable of strategically tracking and monitoring the location of other nearby TAG devices 4a to 4n.

Further, the inventors discovered that a particular TAG device 4a to 4n may not have enough capacity in its electronic memory 22 to effectively track and monitor the location of all other TAG devices 4a to 4n.

Accordingly, the inventors yet further discovered a method that includes a preference selection process. For example, in one embodiment if an inventive TAG device 4a to 4n (hereafter “reference” TAG device) receives data indicating the positions of certain surrounding, nearby TAG devices 4a to 4n, then the reference TAG device 4a to 4n may be able to determine whether or not a message (e.g., communication frame) from one TAG device 4a to 4n (“originating” TAG device) requires relaying or retransmission based on the distance between the originating TAG device 4a to 4n and the gateway 3 and the transmission capability (i.e., transmission range) of the originating TAG device 4a to 4n.

In embodiments of the disclosure the inventors further discovered that there were potentially a number of reference TAG devices 4a to 4n for each such message (i.e., frame) that may need to be relayed or retransmitted. Accordingly, the inventors discovered methods for determining which reference TAG device 4a to 4n that surrounds an originating TAG device 4a to 4n should be selected to relay or retransmit the original message (“selected” TAG device). More particularly, in an embodiment an inventive microcontroller 21 may be configured with the inventive frame relay section 203 described above to determine the selected TAG device 4a to 4n.

It can be said that one of the goals of the inventive microcontroller 21, task manager 205, frame relaying section 203 and stack 201 is to allow a communication frame to “travel” straight through the stack 201, only being delayed if another device is already re-transmitting the frame. Said another way, in an embodiment, the microcontroller 21 of an inventive TAG device 4a to 4n may be configured to retrieve and execute code or instructions stored in the task manager 205, frame relaying section 203 and stack 201 (all of which is stored in flash memory 22) that allows a communication frame to be generated and transmitted or received and processed substantially faster than existing methods (i.e., existing communication stacks).

For example, an existing method (stack) may delay the generation of a frame due to (i) the detection of a transmit and/or receive mode change, (ii) possible foreground and background scanning, or (iii) the use of a timing strategy. In embodiments, the inventive method completed by a microcontroller 21 of an inventive TAG device 4a to 4n executing code stored in the task manager 205, frame relaying section 203 and stack 201 does not delay the generation of a communications frame when such changes are detected, scans occur or due to the existence of such timing strategies.

Similarly, upon receiving a communications frame such a received frame may also “travel” straight through the stack 201. Said another way, in an embodiment, a microcontroller 21 may retrieve, complete and execute code or instructions stored within the task manager 205, frame relaying section 203 and stack 201 of its flash memory 22 to process the received communications frame and relay or retransmit the frame without delay due to (i) the detection of a transmit and/or receive mode change, (ii) possible foreground and background scanning, or (iii) the use of a timing strategy. In embodiments, the inventive method does not delay the relaying and retransmission of a received frame when such changes are detected, scans occur or due to the existence of such timing strategies.

In embodiments, a TAG device 4a to 4n or gateway 3 may be configured for longer or shorter transmission ranges with the trade-off being slower or faster transmission rates.

For example, as noted briefly above an inventive microcontroller 21 may be configured to access data that may be configured and stored as an access profile in an access profile section 202 of memory 22. An access profile may comprise stored data that indicates the transmission range of the one or more TAG devices 4a to 4n and/or gateway 3. Thereafter, the microcontroller 21 may be configured to execute code to control the selection of the TAG device 4a to 4n that a communication frame may be successfully relayed or re-transmitted to, for example, based on the methods described previously above as well as the data stored in the access profile section 202, it being understood that a successful relay or retransmission requires the data to indicate those TAG devices 4a to 4n that have sufficient transmission ranges and/or rates and those that do not for a given relay or retransmission.

Relatedly, the stored transmission ranges and rates in the access profile section 202 may be linked to the number of TAG devices 4a to 4n in the network 1. Accordingly, to address the challenge of transmitting and receiving communication frames in real time while the number of TAG devices 4a to 4n in the network 1 increases (which requires an increase in the data transmission rate but decrease in transmission range) each TAG device 4a to 4n must “listen” to every other surrounding TAG device 4a to 4n.

For the reader's benefit the inventors provide the following sample information which illustrates how the transmission range and bandwidth of a TAG device 4a to 4n may change as the number of TAG devices increases for five different Access Profiles (i.e., Access profile #1 includes 4 TAG devices while Access Profile #5 includes 46 TAG devices) based on experimental test results the inventors performed using Semtech's LoRa calculator at https://lora-developers.semtech.com/build/tools/calculator/ (“Max” means maximum transmission power):
Access Profile 1 2 3 4 5
# of TAG Devices 4 6 11 23 46
Tx Power Max Max Max Max Max
Spread Factor 7 7 6 6 6
Bandwidth 125 125 125 225 500
Range (miles)* 0.851 0.851 0.720 0.590 0.428

In the information set forth above, considerations of collision avoidance were considered to calculate the number of TAG devices 4a to 4n that could possibly report their locations in real time (see paragraphs above, re: time delay discussion).

As noted previously the inventive methods allow a communication frame that has been received or that will be transmitted to “travel” through an inventive communication stack faster than existing methods (i.e., the computer program code making up the task manager 205, frame relaying section 203, access profile section 202 and stack 201 is executed by a microcontroller 21 faster than existing methods). In an embodiment, to achieve this the inventive method does not require a communication frame to “travel” from one layer 301a to n to another layer 301a to n. Instead, as described previously, the microcontroller 21 generates “pointers” to a task item in task item section 207 which includes the frame.

In more detail, the task item section 207 of memory 23 may store a plurality of data structures, each structure comprising the following information:
Message type (an enumerated value);
Alarm Time (may or may not be used);
Time-out (may or may not be used);
Message Status (an enumerated value);
Packet Queue Index (the slot number where the packet (frame, header and footer) is located) (may or may not be used).

In one embodiment a microcontroller 21 may access and execute code stored in each layer 301a to n of the stack 201. Some of the code in a given layer 301a to n may cause the execution of a specific function by the microcontroller 21. In an embodiment, one such inventive function may be the generation of a request signal (i.e., a “function is called”) that is sent to the task manager 205. Upon receiving the request signal the task manager 205 may determine if there are any tasks in the task items 207 section (i.e., processes) for the layer 301a to n that originated the request signal to complete (i.e., for the microcontroller 21 that is executing the code in the originating layer to complete). If yes, the task manager 205 (i.e., microcontroller 21 executing code of the task manager 205) may in conjunction with the microcontroller 21 generate a valid “pointer” (e.g., an electronic signal) which indicates to the originating layer 301a to n that the frame and code for completing the task is located in the task item section 207 of memory 23.

Alternatively, rather than invoking the task manager section 205, a layer 301a to n in conjunction with the microcontroller 21 may generate a valid pointer itself and pass the pointer on to another layer 301a to n (“requested layer”). Upon receiving the pointer, the requested layer 301a to n may be directed to the code for completing the task that is located in the task item section 207 of memory 23.

If a communication frame needs to be canceled for some reason, there is no need to notify a layer, or reinitialize a layer. The layer in conjunction with the microcontroller 21 simply responds to the task associated with the canceled communication frame.

### Physical Layer

The physical layer 301f of the stack 201 is comprised of code that when executed by a microcontroller 21 configures and controls the LoRa transceiver module 20a. For example, the microcontroller 21 may execute code from the physical layer 301f to configure or control a modifiable driver module 206 which in turn may configure and control peripheral devices. For example, if a transmitter 24a or receiver 24b are replaced with a different transmitter or receiver, then the inventors have configured the LoRa transceiver module 20a such that the transmitter 24a or receiver 24b can be replaced by modifying the driver module 206 but without modifying the stack 201.

In embodiments, an inventive microcontroller 21 may execute code from the physical layer 301f to direct the configuration of the radio 24 according to an access profile selected from section 202 during execution of code by the microcontroller 21 from an upper layer 301a to 301n of the stack 201. Such configurations may pertain to changes to the radio's 24 modulation technique, symbol rate, modulation index, symbol, TX power, and/or other settings of the radio 24 in use. In an embodiment, an experimental LoRa transceiver module 20a incorporated a radio 24 that made use of Semtech's LoRa communication technique. Therefore, the configuration is expected to be similar if a different radio is used.

The experimental LoRa transceiver module 20a may include a transmitter 24a and receiver 24b that transmits/receives using frequencies within a 928 MHz frequency band. However, this disclosure also covers a LoRa transceiver module 20a that includes a transmitter 24a and receiver 24b that transmits/receives using frequencies within a 915 MHz ISM frequency band (e.g., frequencies within the range of 912 MHz to 928 MHz) as well as other ISM frequency bands, including those frequencies used for LoRa communication in countries other than the United States.

In embodiments, the microcontroller 21 may execute code from the physical layer 301f that causes the LoRa transceiver module 20a to perform the following functions or enter the following modes:

### Mode Description

Sleep In a low power consumption state
Idle/Standy Not transmitting or receiving but ready to do so
TX Transmitting
RX Receiving or listening to receive

Due to the need to track the position of TAG devices 4a to 4n and gateway 3 and to support the inventive frame relaying, an inventive LoRa transceiver module 20a of an inventive TAG device 4a to 4n or gateway 3 may operate mostly in RX and TX modes.

Still further, the physical layer 301f may include optional code that, when executed by the microcontroller 21, performs data whitening functions in order to smooth power distribution over a frequency bandwidth and improve the performance of the radio 24.

### Data Link Layer

Some of the features and functions of this layer have been described above. In more detail, a microcontroller 21 may be configured to execute code stored in this layer to complete the following functions or processes (i.e., modes):

### Mode Description

Idle Not sending or receiving but ready to do so;
CCA Prep Determine and start the wait time for a clear channel assessment reading;
CCA Wait The wait before a clear channel assessment reading;
CCA Read The reading and determination of a clear channel assessment;
TX Work on a communication frame and pass it to the physical layer; and
RX Receive and process a communication frame.

In an embodiment, the most used operating mode may be the RX mode. In this mode the microcontroller 21 that is executing code from the data link layer 301e is waiting to receive messages (e.g., communication frames). Upon receiving a frame and after executing code within the physical layer 301f, the microcontroller 21 may execute code within the data link layer 301e to perform a cyclic redundancy check (CRC). Upon determining that the received frame has passed the CRC check the microcontroller 21 may execute additional code in the data link layer (DLL) 301f to disassemble and inspect DLL header information within the frame. If the microcontroller 21 determines that the frame is not intended for the receiving TAG device 4a to 4n, the microcontroller then begins to execute code it retrieves from the tag location tracking section 204 as described previously above. However, if the microcontroller 21 determines the received frame is addressed to the receiving TAG device 4a to 4n, the microcontroller begins to execute code related to the next layer 301a to 301f of the stack 201.

Conversely, when it is time to transmit a communication frame, the microcontroller 21 executes code within the DLL layer 301e to complete a clear channel assessment (CCA) preparation and “wait” process which generates a value indicating how long of a wait time is needed before a receiver signal strength indicator measurement of a transmitting TAG can be read. In an embodiment, if a radio of a receiving TAG device was previously transmitting, its radio needs time to switch to a receiving mode, settle and acquire some signal strength measurements before an RSSI reading could be requested from the radio of the receiving TAG device.

In an embodiment, an inventive microcontroller 21 may be configured to determine how long the radio of a receiving TAG device has already been in receive mode. Because most of the time the radio is listening in a receive mode, the wait time will be zero.

In such an instance, a microcontroller 21 may begin to execute code to complete a CCA Read mode. However, in the rare cases the wait time is substantial, the microcontroller 21 may execute code within the DLL layer 301e to delay all transmission related tasks. Still further, if during the time period of a determined wait time another message (frame) is received, the microcontroller 21 may process such a received frame using the stack 201.

In an embodiment, the execution of code comprising the CCA Read mode results in the completion of an RSSI measurement. If a microcontroller 21 determines that the measured RSSI value is at, or below, a specified (acceptable) value, the microcontroller 21 may transition to a TX mode where the message is moved on through the stack for transmission. One important aspect that the inventors considered is the specified RSSI value for indicating a clear channel.

In more detail, an inventive LoRa transceiver module 20a may be configured to use a LoRa communication technique which makes it possible to communicate at, and sometimes just below, the electrical noise floor of a radio 24. Depending on the location of the radio 24, its noise floor may vary from location to location. Recognizing this, the inventors sought to keep the CCA value as low as possible. If such a value becomes too high, a TAG device 4a to 4n may transmit over top of devices farther away, thereby reducing the effective communication range. To address this, an inventive microcontroller 21 may optionally detect and store RSSI measurements and adjust the CCA RSSI value as needed.

Considering cases when the CCA RSSI value indicates another device is transmitting, the task associated with the communication frame has its status marked as waiting for CCA. When the execution path of a microcontroller 21 reaches the routine operations function of the DLL layer, it will find the task and again check for a passing CCA RSSI value. This continues until either the frame is sent, or a timeout occurs, and the frame is marked as having timed out. The responding action to the timeout is determined at the application layer and depends on the need to resend it.

Some experimental headers and footers for an experimental DLL layer within a frame may contain the following items/values.

### Location Name Description

Header Length The length of the payload
Header Subnet The identification of the subnet this device is part of
Header Control Parameters Control parameters (TBD)
Header Target Address The address of the device the message is intended for. (8 bytes)
Footer CRC Cyclic redundance check value as calculated by the sender

Not all data items in the header have been solidified. The communication stack is still at a level of development. As performance needs are evaluated, the header data items would be further specified.

### Network Layer, 301d

During the execution of code associated with the network layer 301d a microcontroller 21 may determine which access profile from the access profile section 202 should be selected. In embodiments, the selected access profile may comprise values (i.e., settings) indicating the frequency, modulation type, and other values which may be used by the radio 24 to transmit and receive frames, for example. One exemplary access profile may include the following settings.

### Setting Value

Frequency 928 MHz
Tx Power 20 dBm
Receiver Mode High Sensitivity
PA Boost On
Ramp Time 40 us
Modulation LoRa
Spread Factor 7
Bandwidth 125 kHz
Coding Rate 4/5
Preamble Length 12 symbols
CRC Off (Is off in hardware but is on in firmware level)
Low Data Rate Optimization On

The inventive LoRa transceiver module 20a may include encryption and decryption sections of the stack 201 to encrypt a payload to be transmitted. Such sections are responsible for initializing AES modulation. Optionally, the following capability (e.g., additional computer program code) may be added into the network layer 301d to be executed by at least the microcontroller 21:
HMAC SHA-256 hashing
AES-128 encryption/decryption
AES-256 encryption/decryption
Unique 72-Bit serial number

In an embodiment, should a microcontroller 21 be configured to assemble an encrypted payload of a communication frame then the microcontroller 21 may execute code stored as a part of the network layer section 301d of the stack 201.

To support message (frame) relaying amongst TAG devices 4a to 4n, the sharing of location data is required. As explained previously, when a TAG device 4a to 4n sends its position to the gateway 3 other TAG devices 4a to 4n “listen” and may save such position information. If, however, the transmitted position data is encrypted then the data needs to be decrypted by a receiving TAG device 4a to 4n.

In an embodiment, a microcontroller 21 may retrieve either a stored common encryption/decryption key (used by more than one TAG device or gateway) or use a unique encryption/decryption key in order to decrypt the position data.

The frame header for this layer 301d may contain the following items (Items are 8-bit values unless otherwise stated):

### Location Name Description

Header Control Control flags (TBD)
Header ID Type Identification type indicator
Header Origin Address The device address from where the frame started from (8 bytes)
Footer NA Not used. Empty space.

Presently, control flags are not used though they may be specified in the future. To date the inventors have focused on testing the communication range and speed of the inventive, experimental LoRa transceiver 20a and its incorporated, experimental microcontroller 21 and stack 201.

In an embodiment, the designation “ID type” is used by a microcontroller 21 to interpret the Origin Address. In present testing an 8-byte value has been used. Optionally, a 9-byte value may be used and possibly a smaller alias address value may also be used.

The frame footer is currently empty.

Presently, the network layer 301d does not have any modes of operation. It has a simple state of being initialized or not initialized. The modes have been optimized out, making this layer indifferent to processing frames being transmitted and frames being received (i.e., the network layer may be turned “on” or “off”).

### Transport Layer, 301c

This layer is under experimental development. Nonetheless, an experimental microcontroller 21 does include experimental code within section 301c of the stack 201 in order to perform experimental testing which consisted of a single message transmission and reception. In an embodiment, during testing the microcontroller 21 executed the experimental code in order to pass frames to be transmitted to another layer of the stack 201 (e.g., a lower layer) and passed frames to be received to yet another layer of the stack 201 (e.g., an upper layer). In embodiments, the microcontroller 21 may also execute code stored within the transport layer section 301c to complete the following:
(i) managing the transmission of large messages that require an ordered set of communication frames;
(ii) managing the reception and reforming of a large messages received one communication frame at a time;
(iii) requesting the retransmission of ill formed frames received; and
(iv) congestion avoidance.

In an embodiment, to avoid blocking other messages (frames) from being sent and received during jobs of sending and receiving large messages, a microcontroller 21 may execute code from within a task management section 205 instead of a transport layer section 301c. However, in an embodiment, the task management section 205 shall not store such a large message, just service a related task when time to do so.

An exemplary, experimental frame header may contain the following data item.

### Location Name Description

Header Control Control flag (TBD)

Header Task ID Task identification from a predefined set.

Header Transaction No. The number associated with the order of a frame as part of a large message.

The frame header contains control flags, task ID, and a transaction number. These values are not used, only placeholders at this time.

The footer is currently empty.

### Session Layer, 301b

This layer is under experimental development. Nonetheless, an experimental microcontroller 21 does include experimental code within section 301b of the stack 201 in order to perform experimental testing which consists of a single message being transmitted and received. In an embodiment, during testing the microcontroller 21 executed the experimental code in order to pass frames to be transmitted to another layer of the stack 201 (e.g., a lower layer) and passed frames to be received to yet another layer of the stack 201 (e.g., an upper layer).

In an embodiment, the inclusion of a task manager section 205 by the inventors relieves this layer 301b of most of its typical responsibilities. Such as FIFOs, priorities, and quality of service management.

Pertaining to the frame headers and footer, the header had two place holders, and the footer is empty.

### Location Name Description

Header Control Control flags (TBD)
Header Session (TBD)

Further development of the application layer 301a may include the addition of responsibilities (e.g., the addition of code that completes, functions and processes) to this layer 301b as well.

### Application Layer, 301a

In embodiments, a microcontroller 21 may be configured differently depending on whether it is contained in a TAG device 4a to 4n or gateway 3. Said another way, the code that is contained in this section 301a of a microcontroller may be different depending on whether it is contained in a TAG device 4a to 4n or gateway 3, and thus the differing code may complete different functions, features and processes as well. For purposes of clarity, the differing functions, features and processes will not be discussed. Instead, we will discuss the common functionalities. Such functionalities that may be completed by a microcontroller 21 executing code stored in an exemplary, experimental application layer 301a may comprise the following:
(i) controls communication stack initialization;
(ii) controls communication stack stop operation;
(iii) “calls” each individual layer's routine operation function;
(iv) instigates message transmission;
(v) processes and responds to instruction messages received;
(vi) cleans up and acts on task that have timed out, become unassigned, or have been misused;
(vii) “calls” tag tracking routine operation function; and
(viii) “calls” communication frame relay routine operation function.

In an embodiment, the microcontroller 21 may execute code stored in the application layer section 301a in order to: (i) perform allocation of a communication frame, (ii) generate task items and assign a frame to one or more of the generated task items, and (iii) sends a frame through the stack to be transmitted.

Though the layer 301a is under experimental development, an experimental microcontroller 21 includes experimental code within section 301a of the stack 201 in order to perform experimental location data reporting.

As previously discussed, but now reiterated, when a TAG device 4a to 4n (i.e., its communication stack) receives a communication frame that is not addressed to it, its microcontroller 21 executes code from its tag location tracking section 204 to determine the position of the device it originated from. Note that before code from the above-described frame relaying section 203 is “called” (i.e., executed), code from the tag location tracking section 204 has already been performed. Said another way, if a “just received” communication frame includes location data from a new TAG device 4a to 4n, its location information will be stored in the tag tracking section 204 before code from the frame relaying section 203 is completed (i.e., before a frame relaying function is “called”).

When the communication frame was received, its signal strength was recorded. A microcontroller 21 may then execute code to determine (based on the received TAG device's location) the originating device's location, and the target TAG device or gateway's location, if the originating TAG device (or gateway) will have enough signal strength to transmit a frame to its destination. If not, or if it's calculated distance from a target device (i.e., destination) is greater than a specified limit, the frame may be stored in the buffer described previously above to be re-transmitted or relayed if possible.

As also noted above, because other neighboring TAG devices 4a to 4n may have received the same communication frame and also saved it in their buffers for possible relaying, it would be wasteful if the same frame was re-transmitted or relayed multiple times. Thus, the inventors discovered the use of the time delay described previously which (again) may include the following: (i) a generated random number; (ii) a battery SOC, (iii) a signal strength from a gateway and (iv) a position relative to a gateway.

As noted earlier, a certain “weight” (i.e., value) may be applied to each factor in determining a time delay. In an embodiment, there are some conditions that will result in a decision not to relay the frame. Generally, a TAG device 4a to 4n with a higher SOC will have a shorter delay.

Before a time delay is reached, if the same communication frame was received again by the same TAG device 4a to 4n, it will be understood as being relayed by another TAG device. If that happens, the frame to be relayed will be canceled and erased from a buffer. The inventors developed the inventive communication stack and processes with this in mind. However, if the time delay is reached, a microcontroller 21 may execute code from a frame relaying section 203 to “load” the communication frame into the communication stack for retransmission/relaying (i.e., the microcontroller 21 performs the functions described previously above to relay or retransmit the frame).

The description above has focused on exemplary embodiments for estimating cargo deliveries. While certain embodiments have been described it should be understood that the inventive methods, systems and devices are not limited to the described embodiments. Other variations of the inventive methods, systems and devices may be implemented.

It should be further understood that the features described above with respect to one embodiment illustrated by one figure, for example, may also be incorporated into another embodiment described herein and/or shown in a different figure. For the sake of clarity, however, such features have not been repeated for each other embodiment.

Numerous changes and modifications to the embodiments disclosed herein may be made without departing from the general spirit of the disclosure, the scope of which is best defined by the claims that follow.

We claim:

1. A long range (LoRa) wireless telecommunications module comprising:
a microcontroller configured to execute computer program code stored within at least one first electronic memory (“first memory”) to cause the LoRa module to complete stored task items stored in a second memory thereby further causing a communication frame to (i) be processed in real time so that the frame may be transmitted by a transceiver without repeatedly passing the frame from one layer of a communication stack to another layer of the communication stack or (ii) be received and processed by the transceiver in real time without repeatedly passing the frame from the one layer of the communication stack to the other layer of the communication stack.

2. The LoRa module as in claim 1 wherein the module comprises part of an Internet-of-Things (IoT) device.

3. The LoRa module as in claim 1 wherein the module comprises a part of TAG device.

4. The LoRa module as in claim 1 wherein the module comprises a part of gateway.

5. The LoRa module as in claim 1 wherein the first memory comprises an electronic flash memory.

6. The LoRa module as in claim 1 wherein the microcontroller is configured to further execute computer program code to:
receive the communication frame containing data to be transmitted or received;
store the frame in a section of the second memory (“task item section”);
execute code of a given layer of the communication stack using the stored communication frame (a “call”) rather than consuming processing time of the microcontroller to electronically process the communication frame in accordance with code from a section of the first memory.

7. The LoRa module as in claim 6 wherein the microcontroller further executes stored code within the first memory to generate a pointer which directs a section of the first memory (“next layer”) to access the communication frame within a stored task item section of the second memory.

8. The LoRa module as in claim 7 wherein the microcontroller further executes stored code within the first memory to:
receive the communication frame from the task item section;
execute a function or process on the communication frame as if the communication frame is a task item.

9. The LoRa module as in claim 1 wherein the first memory and the second memory are combined into one memory.

10. A long range (LoRa) wireless telecommunications module comprising:
a microcontroller configured to execute computer program code stored within at least one first electronic memory to,
control generation of a first pointer that directs a layer of a communication stack stored in the at least one first electronic memory to access a communication frame as a task item stored in a second memory and then execute a function or process using the so accessed frame in accordance with accessed the task item.

11. A long range (LoRa) wireless telecommunications module comprising:
a microcontroller configured to execute computer program code stored within at least one first electronic memory to,
store and execute service function code in a reference layer of a communication stack;
generate a second pointer; and
access code stored in a task manager section, wherein the accessed code comprises a task item that includes a communication frame to be transmitted or a received communication frame.

12. The long range (LoRa) wireless telecommunications module as in claim 11 wherein the microcontroller is further configured to execute computer program code stored within the at least one first electronic memory to,
determine whether the task item refers to the reference layer; and
upon determining that the task item refers to the reference layer execute the task item in accordance with code of the reference layer to ensure real time processing of the communication frame to be transmitted or the received communication frame, or upon determining that the task item does not refer to the reference layer ignores the task item and execute subsequent code of the reference layer.

13. A TAG device in a long range (LoRa) wireless telecommunications network comprising:
an electronic microcontroller configured to execute computer program code stored within at least one electronic memory to cause the TAG device to,
determine when an electronic storage capacity of a tag location tracking section of the microcontroller is approaching a maximum capacity; and
upon detecting a maximum or near maximum storage capacity of the tag location tracking section, updating previously stored position data stored within the tracking section indicating previous positions of one or more other TAG devices with present position data.

14. The TAG device as in claim 13 wherein the microcontroller is further configured to execute computer program code to receive the present position data from the one or more other TAG devices.

15. A TAG device in a long range (LoRa) wireless telecommunications network comprising:
an electronic microcontroller configured to execute computer program code stored within at least one electronic memory to cause the TAG device to,
determine whether a received communication frame is intended for the TAG device;
if the communication frame is not intended for the TAG device, further execute computer program code stored within a tag location tracking section to determine whether the tag location tracking section has stored a position of a second TAG device that sent the communication frame before executing computer program code from a frame relaying section;
determine whether the communication frame contains position data from a third TAG device; and
store the communication frame within the tag location tracking section if the frame contains position data from the third TAG device before executing code from the frame relaying section.

16. The TAG device as in claim 15 wherein the electronic microcontroller is further configured to execute computer program code stored within the at least one electronic memory to cause the TAG device to,
determine a destination device of the communication frame; and
determine whether or not the second TAG device has a transmission signal strength to transmit the frame directly to the destination device without the frame being relayed or re-transmitted.

17. The TAG device as in claim 16 wherein the microcontroller is further configured to store the communication frame in an electronic buffer memory upon determining that the transmission signal strength of the second TAG device is insufficient to allow the communication frame to be received at the destination device.

18. The TAG device as in claim 17 wherein the destination device comprises the third TAG device.

19. The TAG device as in claim 17 wherein the microcontroller is further configured to:
initiate an electronic clock timer;
monitor a time value;
compare the monitored time value to a time delay value; and
when the comparison indicates that the monitored time value equals or exceeds the time delay value, initiate re-transmission or relaying of the communication frame from the buffer, provided, no interrupt signal is received.

20. The TAG device as in claim 19 wherein the microcontroller is further configured to generate the time delay value based on one or more of the following: a generated random number; a battery state-of-charge (SOC) of a transmitting TAG device; a signal strength of gateway device; or a distance from a gateway device of the transmitting TAG device.
